(19) United States
(12) Patent Application Publication
(10) Pub. No.: US 2010/0193611 A1
(43) Pub. Date: Aug. 5, 2010

(54) THROTTLE ON A VALVE NEEDLE OF A FUEL INJECTION VALVE FOR INTERNAL COMBUSTION ENGINES

(76) Inventors: Matthias Burger, Murr (DE); Hans-Christoph Magel, Reutlingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/668,936

(22) PCT Filed: Jun. 13, 2008
(86) PCT No.: PCT/EP2008/057451

§ 371 Date: Jan. 13, 2010

(30) Foreign Application Priority Data
Jul. 13, 2007 (DE) 102007032741.4

(51) Int. Cl. F02M 61/10

(52) U.S. Cl. 239/533.11

(57) ABSTRACT

The invention relates to a fuel injection valve for internal combustion engines, having a valve body, in which a pressure chamber is configured. A valve needle is disposed in the pressure chamber in a longitudinally displaceable manner. The valve body has a valve seat which interacts with a sealing surface configured on the valve needle. The valve seat delimits the pressure chamber, thus enabling or interrupting a fuel flow to at least one injection opening by the interaction of the valve needle with the valve seat. To this end, the fuel flow to the injection openings occurs between the valve needle and the wall of the pressure chamber, through a sharp-edged gap throttle which is formed between the valve needle and the wall of the pressure chamber.

The invention relates to a fuel injection valve for internal combustion engines, of the kind preferably used for injecting fuel at high pressure directly into a combustion chamber of an internal combustion engine. Its use in fuel injection of self-igniting internal combustion engines is especially advantageous.

### PRIOR ART

In the development of internal combustion engines, high priority is given to adhering to pollutant limit values. The common rail injection system precisely has made a significant contribution to reducing pollutants, and a decisive point is that the common rail system can provide precise injections at any time, regardless of the injection pressure and of the engine rpm and the load on the engine. For injecting the fuel, stroke-controlled common rail injectors are known, whose valve needle is servo-operated. The corresponding control valves are controlled by piezoelectric or magnetic actuators, which switch very quickly and thus make fast opening of the valve needles possible.

For attaining various partial injections, especially preinjections and postinjections with a very small fuel quantity, however, it is also necessary that the nozzle needle close correspondingly fast. Various concepts for doing this have been developed, such as a permanent low-pressure step on the nozzle needle that constantly exerts a closing force and thus accelerates the closing motion of the valve needle. However, such a low-pressure step has the disadvantage of entailing high leakage and thus necessitates a greater pumping power, which leads to sacrifices in efficiency of the system and thus to higher fuel consumption. This circumstance can become problematic, especially as even higher pressures are introduced.

For this reason, the most recent injectors for extremely high injection pressures are embodied as leak-free by dispensing with this low-pressure step. However, then for closing the valve needles only slight forces are available, which lessens the capability of injecting extremely small quantities. This disadvantage can be compensated for only with very great difficulty, for instance by using suitably fast-switching control valves, but this is expensive and complicated.

Valve needles of the kind known for instance from German Published Patent Application DE 100 24 703 A1 are guided in a middle guide portion in the pressure chamber of the injection valve, and the fuel is moved past the valve needle by means of two, three or four polished faces. The throttle restriction thus brought about leads to a pressure drop in this region, so that the pressure in the pressure chamber upstream of the guide portion is greater than downstream of the guide portion, which exerts a permanent closing force on the valve needles and partly compensates for the aforementioned disadvantages. However, then the problem arises that the throttling action is dependent on the viscosity of the fuel, which in turn is a function of the pressure and temperature. Thus over a wide operating range of the fuel injection valve, the pressure drop and hence the needle closing force are dependent on the temperature and pressure, resulting in a variation in the fuel metering quantity from one injection to another. The resultant imprecisions in fuel quantity metering have an adverse effect on pollutant emissions from the engine.

### ADVANTAGES OF THE INVENTION

By means of the fuel injection valve of the invention, a defined throttle restriction is created, which brings about a pressure drop regardless of the Reynolds' number of the fuel, so that the throttling action is independent of the temperature. As a result, a permanent and constant closing force on the valve needle is attained, which ensures fast needle closure and hence good capability of the fuel injection valve for extremely small quantities. To that end, a sharp-edged gap throttle is embodied between the valve needle and the wall of the pressure chamber; given suitable dimensioning, this gap throttle brings about a pressure drop that is independent of the Reynolds' number of the fuel. The Reynolds' number depends among other things on the density and the dynamic viscosity, which in turn are determined substantially by the temperature of the fuel. Because of the independence of the Reynolds' number, the damping action of the gap throttle becomes independent of the temperature and is thus constant, the effect of which is a constant closing force on the valve needle.

The gap throttle, in a first advantageous feature of the subject of the invention, is embodied by a collar, which on its outer edge has a sharp edge, so that between the edge of the collar and the wall of the pressure chamber, the sharp-edged gap throttle is formed. If a guide portion is provided on the valve needle, the collar can then be embodied both upstream and downstream of the guide portion.

For carrying the fuel through, it advantageously be provided that one or more polished faces are embodied on the collar which likewise have a sharp edge, so that the independence from the Reynolds' number is preserved. The flow rate and thus the throttling action of the gap throttle and the closing force can be determined by the size of the polished faces. For optimizing the throttling action with constant stability of the collar, an essentially triangular cross section of the collar, which comes about by means of three polished faces, is advantageous. The collar can then be embodied in one piece with the valve needle, or it can also, after the valve needle has been made, be glued, welded or shrink-fitted onto the valve needle.

### DRAWINGS

In the drawings, a fuel injection valve of the invention is shown. In the drawings:

FIG. 1 is a longitudinal section through a fuel injector with an injection valve according to the invention;

FIG. 2 shows the injection valve shown in FIG. 1, schematically showing only the part toward the combustion chamber with the essential components; and

FIG. 3a through

FIG. 3c show various designs of the collar and hence of the gap throttle.

### DESCRIPTION OF THE EXEMPLARY EMBODIMENT

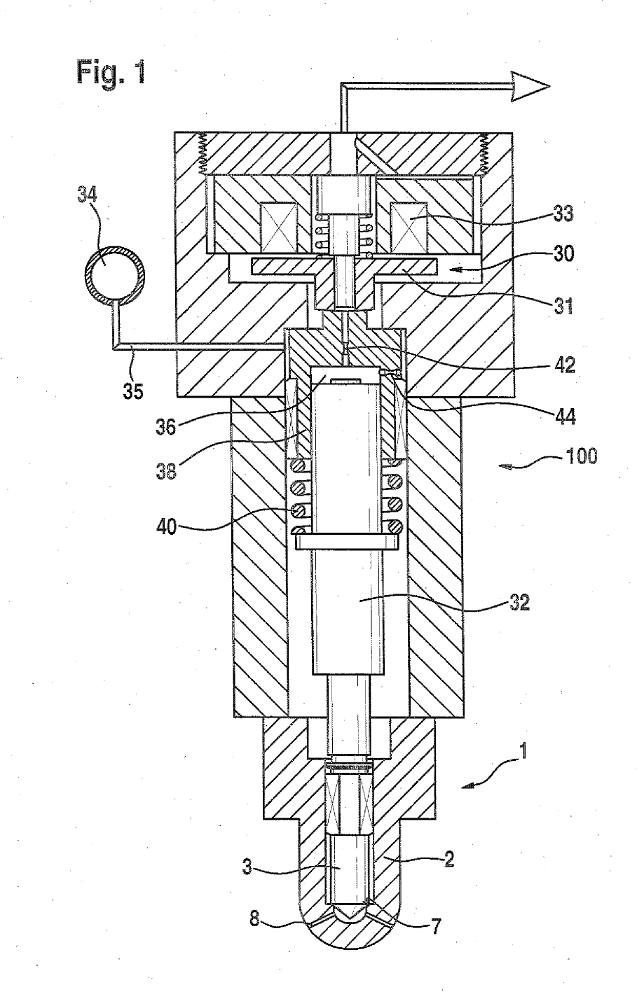

In FIG. 1, a fuel injector is shown in longitudinal section. The basic principle of such injection valves is well known from the prior art, so that a detailed description of the known components can be dispensed with, and only their function will be briefly outlined below. The fuel injector includes a fuel injection valve 1 and an injector body 100, which contains a control valve 30 for controlling the injection. The injector body 100 is connected to the fuel injection valve 1, which includes a valve body 2 and in which injection openings 8 are present, by way of which the fuel is ejected. A valve needle 3 is disposed in the valve body 2 and is connected to a piston rod 32; the piston rod 32, with its face end, defines a control chamber 36 that is embodied in a sleeve 38. By means of the spring 40, the piston 32 and thus the valve needle 3 as well are pressed against a valve seat 7, as a result of which the injection openings 8 are closed.

The control chamber 36 can be made to communicate with a pressureless leak fuel chamber via an outlet throttle 42, which can be opened or closed by the control valve 30. For the sake of this communication, an armature 31 of the control valve is attracted by an electromagnet 33, so that the outlet throttle 42 is opened and fuel can flow out of the control chamber 36 into the leak fuel chamber. To terminate the injection, the current supply to the electromagnet 33 is switched off, and the armature 31 slides under spring pressure back into its outset position and closes the outlet throttle 42. Via the inlet throttle 44, the fuel that has flowed out is replenished in the pressure chamber 36. The compressed fuel is made available in a high-pressure reservoir 34, known as a rail, and as is delivered to the fuel injection valve via a high-pressure line 35.

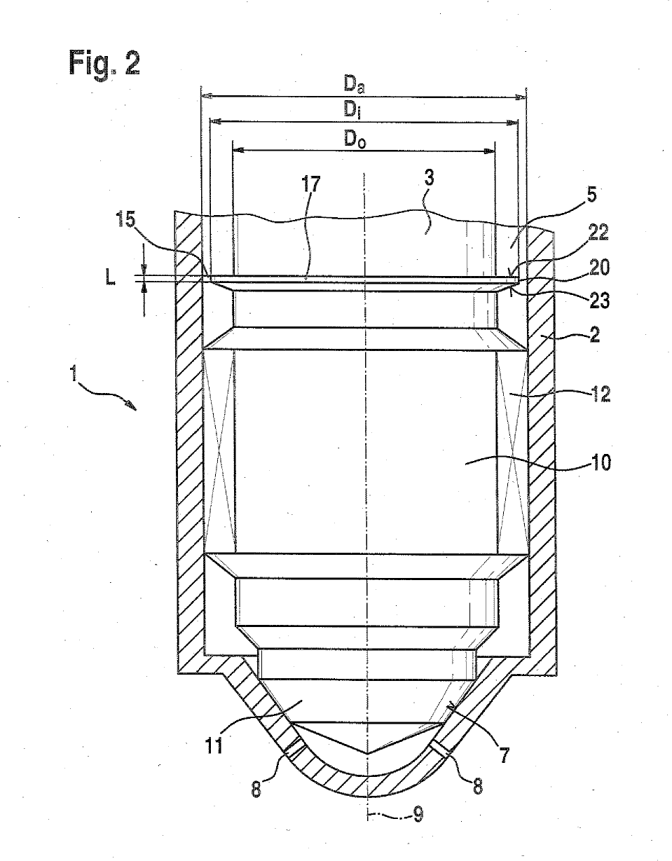

In FIG. 2, the fuel injection valve of FIG. 1 is shown enlarged in longitudinal section; only the part of the injection valve that faces toward the combustion chamber in the installed position is shown. The fuel injection valve 1 includes a pressure chamber 5, which can be filled with fuel at high pressure and which is defined, toward the combustion chamber, by the valve seat 7, which is embodied as essentially conical and from which a plurality of injection openings 8 extend. In the pressure chamber 5, the valve needle 3 is disposed longitudinally displaceably, and the valve needle is embodied in pistonlike fashion with an axis 9. The valve needle 3 is guided in a guide portion 10 in the pressure chamber 5, so that relative to the conical valve seat 7, the valve needle is always oriented precisely in the center. The fuel that flows to the injection openings 8 flows through the annular gap remaining between the valve needle 3 and the wall of the pressure chamber 5 and is conducted in the region of the guide portion 10 through a plurality of polished faces 12, which make a sufficiently large flow cross section available. On the end of the valve needle 3 toward the valve seat, a sealing face 11 is embodied, with which the valve needle 3 cooperates with the valve seat 7. As a result, upon contact of the valve needle 3 with the valve seat 7, the fuel flow from the pressure chamber 5 to the injection openings 8 is interrupted and is not opened up again until the valve needle 3 lifts from the valve seat 7.

Upstream of the guide portion 10, a collar 17 is embodied on the valve needle 3, extending annularly over the entire circumference of the valve needle 3. The collar 17 is embodied as sharp-edged on its outside, and the edge 20 thus formed has a length L. This creates a sharp-edged gap throttle 15 between the wall of the pressure chamber 5 and the edge 20.

The mode of operation of the fuel injection valve is as follows: At the onset of the injection cycle, the valve needle 3 is in its closed position, or in other words is in contact with the valve seat 7. By a closing force, which is generated hydraulically by the pressure in the control chamber 36, the valve needle 3 is pressed against the valve seat 7. In the pressure chamber 5, there is fuel at high pressure, but because of the closing force, it does not exert any resultant force in the longitudinal direction on the valve needle 3. If an injection is to occur, then the closing force is reduced, and the valve needle 3 lifts from the valve seat 7 and enables a flow of fuel out of the pressure chamber 5 to the injection openings 8. For closing the valve needle 3, the closing force is increased again, so that the valve needle 3 experiences a resultant force against the valve seat 7 and slides back into its closed position.

To accelerate this closing motion, the collar 17 acts as follows: By means of the gap throttle 15, a pressure drop results there, so that in the part of the pressure chamber 5 that is upstream of the collar 17, a greater pressure prevails than downstream. As a result, a hydraulic force which is oriented upstream acts on a first pressure face 22 of the collar 17 and is greater than the hydraulic force on a second pressure face 23 that is embodied opposite the first on the collar 17. This resultant hydraulic force on the collar 17, which is oriented in the direction of the valve seat 7, helps to close the valve needle 3 faster than would be the case if only the closing force on the end of the valve needle 3 remote from the valve seat were increased.

The magnitude of this closing force depends decisively on the magnitude of the pressure drop at the gap throttle 15. The magnitude of the pressure drop is in turn dependent on the cross section of the gap throttle 15 and on the viscosity of the fuel, which is a function of the temperature and pressure in the pressure chamber 5. As a result of the sharp-edged embodiment of the edge 20, it is attained that the pressure drop and thus the damping at the gap throttle 15 are independent of the Reynolds' number and thus are also independent of the viscosity and temperature of the fuel. The results are thus an always-constant closing force on the valve needle 3 and replicable closing behavior, independently of the operating point and independently of the temperature of the fuel.

The above-described effect occurs in a similar way at the guide portion 10 and at the polished faces 12 as well, but in that case the pressure drop depends markedly on the Reynolds' number. In this exemplary embodiment, care must therefore be taken that the polished faces 12 be embodied as large enough that only a very slight pressure drop, or none at all, occurs, with a corresponding additional closing force at the guide portion 10.

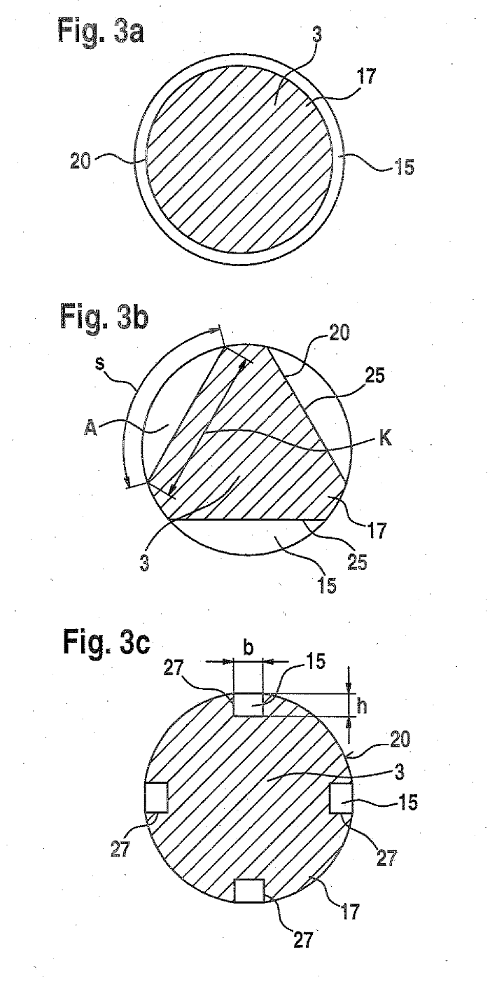

FIG. 3a shows a top view on the collar 17 and the gap throttle 15. It is important for the function that the gap throttle 15 be formed by a sharp edge 20. The size of the hydraulic diameter D_{hyd}, which is defined by the flow cross section and the boundary length through which there is a flow, is decisive; the boundary length is the sum of the inner and outer boundary lengths. The following general equation applies:

$${D}_{Hyd} = 4 \cdot \frac{flow cross section}{flow boundary length}$$

For explanation, see FIG. 3a, in which the gap throttle 15 is an annular gap, with an outside diameter Dₐ and an inside diameter Dᵢ; the outside diameter Dₐ is equivalent to the inside diameter of the pressure chamber 5, and the inside diameter Dᵢ is equivalent to the diameter of the collar 17. The hydraulic diameter D_{Hyd} is then defined in a good approximation by the equation

D_{Hyd}=Dₐ−Dᵢ

If L is the length of the edge 20, then for the independence of the Reynolds' number for a gap throttle 15, the condition

L/D_{Hyd}<5

must be met, so that it is sharp-edged in the sense of his invention.

If D₀ is the diameter of the valve needle 3 immediately upstream of the collar 17, then the optimal function is attained if furthermore the following condition is met:

$$\frac{\begin{matrix}narrowest throttle cross \\ section upstream of the gap throttle\end{matrix} }{cross section upstream of the gap throttle} < 0.2$$

In the case of FIGS. 2 and 3a, this means the same as

$$\frac{{D}_{a}^{2} - {D}_{i}^{2}}{{D}_{a}^{2} - {D}_{0}^{2}} < 0.2$$

FIG. 3b shows an alternative embodiment of the collar 17, in which lateral polished faces 25 are provided that lend the collar 17 an essentially triangular shape in cross section. The polished faces 25 are shown exaggerated here for the sake of clarity, and the length K of these polished faces 25 naturally depends on the length L of the collar 17. Instead of three polished faces as shown in FIG. 3b, a greater number of polished faces 25 may also be provided, such as four, five or six polished faces 25.

In the exemplary embodiment of FIG. 3b, the hydraulic diameter D_{Hyd} must be calculated in a different way from the exemplary embodiment of FIG. 3a. If S is the arc length of the polished face 25, K is the edge length of the polished face 25, and A is the area which is formed by one of the polished faces 25 between the polished face 25 and the wall of the pressure chamber 5, then D_{Hyd} becomes

$${D}_{Hyd} = \frac{4 \cdot A}{S + K}$$

FIG. 3c shows a further feature of the collar 17; here the gap throttle 15 is embodied by a plurality of grooves 27 in the collar 17, and the maximum length L of the collar 17 in this case depends on the dimensioning of the grooves 27. Between the grooves 27, the remaining gap between the valve needle 3 and the wall of the pressure chamber 6 is dimensioned such that a seal is present in practical terms, and the fuel thus flows solely through the grooves 27. The boundary of the grooves 27 is embodied as sharp-edged, so that the independence of the Reynolds' number is preserved.

The exemplary embodiment of FIG. 3c is calculated as follows: If b is the width of the groove 27 and h is its depth, then

$${D}_{Hyd} = 2 \frac{h \cdot b}{h + b}$$

The gap throttle 15 can be disposed inside or outside the guide portion 10.

Throttling independent of the Reynolds' number at a gap throttle can accordingly be attained only if the gap throttle is sharp-edged in accordance with the above definitions. On one side of the components forming the gap throttle 15, a sharp edge may be present, while on the other side there is a smooth wall, like the wall of the pressure chamber 5 in the above example. It can also be provided that the gap throttle 15 is formed by a sharp boundary on both sides, for instance in that opposite the sharp-edged collar 17 in the above exemplary embodiment of FIG. 3a, there is an equally sharp-edged burr on the inner wall of the pressure chamber 5. If the opening stroke of the valve needle 3 is not overly long, the action is preserved during the entire opening event. However, it is also possible to align the collar and the burr with one another in such a way that the maximum damping action does not occur until the open state of the nozzle needle 3, or in other words until the collar and the burr are precisely opposite one another, while at the onset of the opening stroke motion, only slight damping is operative at the gap throttle, which promotes the pressure buildup at the injection openings 8.

1-9. (canceled)

10. A fuel injection valve for internal combustion engines, having
a valve body in which a pressure chamber,
a valve needle disposed longitudinally displaceably in the pressure chamber,
a valve seat of valve body defining the pressure chamber and cooperating with a sealing face embodied on the valve needle, and by cooperation of the valve needle with the valve seat, a fuel flow to at least one injection opening is enabled or interrupted, and a fuel flow between the valve needle and a wall of the pressure chamber flows through to the injection openings, wherein between the valve needle and the wall of the pressure chamber, a sharp-edged gap throttle is embodied.

11. The fuel injection valve as defined by claim 10, wherein on the valve needle, a collar is embodied which on its outer edge has a sharp edge, so that the sharp-edged gap throttle is embodied between the collar and the wall of the pressure chamber.

12. The fuel injection valve as defined by claim 10, wherein the sharp-edged gap throttle meets the condition L/D_{Hyd}<5, where L is the length of the gap throttle, and D_{Hyd} is the hydraulic diameter.

13. The fuel injection valve as defined by claim 11, wherein the sharp-edged gap throttle meets the condition L/D_{Hyd}<5, where L is the length of the gap throttle, and D_{Hyd} is the hydraulic diameter.

14. The fuel injection valve as defined by claim 12, wherein the edge has a same length L as the gap throttle and a diameter Dᵢ, and the pressure chamber in the region of the collar has a diameter Dₐ and the relationship L/(Dₐ−Dᵢ)<5 is met.

15. The fuel injection valve as defined by claim 13, wherein the edge has a same length L as the gap throttle and a diameter Dᵢ, and the pressure chamber in the region of the collar has a diameter Dₐ and the relationship L/(Dₐ−Dᵢ)<5 is met.

16. The fuel injection valve as defined by claim 11, wherein the collar, on its outside, has one polished face or a plurality of polished faces.

17. The fuel injection valve as defined by claim 16, wherein the edge of the collar is embodied as sharp-edged in a region of the polished faces, and a region between the polished faces is largely sealed off by the wall of the pressure chamber, so that fuel moves past the collar practically only in the region of the polished faces.

18. The fuel injection valve as defined by claim 11, wherein in the collar, one or more grooves are embodied, and the collar, in a region between the grooves, largely seals by means of the wall of the pressure chamber, so that fuel flows practically only in the region of the grooves.

19. The fuel injection valve as defined by claim 18, wherein a boundary of the grooves is embodied as sharp-edged.

20. The fuel injection valve as defined by claim 10, wherein the valve needle is guided by a guide portion of the pressure chamber through the wall of the pressure chamber, and the gap throttle is disposed upstream or downstream close to the guide portion.

21. The fuel injection valve as defined by claim 11, wherein the valve needle is guided by a guide portion of the pressure chamber through the wall of the pressure chamber, and the gap throttle is disposed upstream or downstream close to the guide portion.

22. The fuel injection valve as defined by claim 12, wherein the valve needle is guided by a guide portion of the pressure chamber through the wall of the pressure chamber, and the gap throttle is disposed upstream or downstream close to the guide portion.

23. The fuel injection valve as defined by claim 13, wherein the valve needle is guided by a guide portion of the pressure chamber through the wall of the pressure chamber, and the gap throttle is disposed upstream or downstream close to the guide portion.

24. The fuel injection valve as defined by claim 14, wherein the valve needle is guided by a guide portion of the pressure chamber through the wall of the pressure chamber, and the gap throttle is disposed upstream or downstream close to the guide portion.

25. The fuel injection valve as defined by claim 15, wherein the valve needle is guided by a guide portion of the pressure chamber through the wall of the pressure chamber, and the gap throttle is disposed upstream or downstream close to the guide portion.

26. The fuel injection valve as defined by claim 16, wherein the valve needle is guided by a guide portion of the pressure chamber through the wall of the pressure chamber, and the gap throttle is disposed upstream or downstream close to the guide portion.

27. The fuel injection valve as defined by claim 17, wherein the valve needle is guided by a guide portion of the pressure chamber through the wall of the pressure chamber, and the gap throttle is disposed upstream or downstream close to the guide portion.

28. The fuel injection valve as defined by claim 18, wherein the valve needle is guided by a guide portion of the pressure chamber through the wall of the pressure chamber, and the gap throttle is disposed upstream or downstream close to the guide portion.

29. The fuel injection valve as defined by claim 19, wherein the valve needle is guided by a guide portion of the pressure chamber through the wall of the pressure chamber, and the gap throttle is disposed upstream or downstream close to the guide portion.
